(19) United States
(12) Patent Application Publication
(10) Pub. No.: US 2009/0239392 A1
(43) Pub. Date: Sep. 24, 2009

(54) Electronic Apparatus

(75) Inventors: Sotaro Sumitomo, Ome-shi (JP); Jun Watanabe, Fussa-shi (JP); Shigeharu Imamura, Ome-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/250,376

(22) Filed: Oct. 13, 2008

(30) Foreign Application Priority Data
Mar. 24, 2008 (JP) 2008-076321

(51) Int. Cl. H01R 11/30

(52) U.S. Cl. 439/39

(57) ABSTRACT

According to one embodiment, An electronic apparatus includes: a receptacle that is not compatible with a plug having a support magnet around a plug terminal; a magnet that is disposed so that one pole of the magnet is opposed to a certain pole of the support magnet when the plug is inserted in the receptacle, the certain pole having the same polarity as the one pole.

### CROSS-REFERENCE TO RELATED APPLICATIONS

This application is based upon and claims the benefit of priority from Japanese Patent Application No. 2008-076321, filed Mar. 24, 2008, the entire contents of which are incorporated herein by reference.

### BACKGROUND

1. Field

The present invention relates to an electronic apparatus in which magnets are provided in both of a connector unit (receptacle) and a plug so that the connector unit and the plug being inserted into the connector unit attract each other.

2. Description of the Related Art

For example, a modem apparatus is connected to a portable personal computer main body by using a connection device of an RS-232C port, a second connector unit that is provided at the tip of an interface cable is fitted into a first connector unit that is provided in the personal computer main body. To make this connection, it is necessary to hold the personal computer main body with one hand and positions the second connector unit and pushes it into the first connector unit a little strongly with the other hand. This manipulation is cumbersome to the user.

In view of the above, connection devices have been proposed which facilitate the attachment and detachment and prevent a reverse connection (refer to JP-A-7-6817). In the connection device of JP-A-7-6817, a first connector unit that is formed with plural contacts and a second connector unit in which plural contacts are formed so as to correspond to the respective contacts of the first connector unit are connected to each other by the attractive forces acting between magnets. This connection device thus facilitates the attachment and detachment.

In the connection device of JP-A-7-6817, a reverse connection can be prevented because a DC plug of an AC adaptor and a DC-in connector are customized. However, this connection device has a problem that erroneous insertion of a plug cannot be prevented. More specifically, for example, the terminals of DC-in plugs are smaller than the openings of connectors that are compatible with RJ45 and RJ11 plugs and hence can be inserted into the openings of those connectors. Should a DC-in plug is inadvertently inserted into the opening of such a connector, the RJ45 or RJ11 connector may be destroyed. Furthermore, development of a connector which can prevent erroneous insertion of a plug and is low in cost is desired.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view of an electronic apparatus according to an embodiment of the present invention.

FIG. 2 is an exemplary front view of connector units.

FIG. 3 is an exemplary perspective view of an example plug to be inserted into a connector unit.

FIG. 4 is an exemplary perspective view of another example plug to be inserted into a connector unit.

FIG. 5 shows an attempt to insert a plug into a connector unit corresponding to it.

FIG. 6 shows another kind of attempt to insert a plug into a connector unit corresponding to it.

FIG. 7 shows an attempt to insert a plug into a connector unit not corresponding to it.

FIG. 8 shows another kind of attempt to insert a plug into a connector unit not corresponding to it.

FIG. 9 shows attempts to insert plugs into connector units.

FIG. 10 shows attempts to insert a plug into a connector unit.

### DETAILED DESCRIPTION

Various embodiments according to the invention will be described hereinafter with reference to the accompanying drawings. In general, according to one embodiment of the invention, an electronic apparatus includes: a receptacle that is not compatible with a plug having a support magnet around a plug terminal; a magnet that is disposed so that one pole of the magnet is opposed to a certain pole of the support magnet when the plug is inserted in the receptacle, the certain pole having the same polarity as the one pole. According to another embodiment of the invention, an electronic apparatus includes: a first receptacle that is compatible with a first plug having a first support magnet around a first plug terminal; a second receptacle that is compatible with a second plug having a second support magnet around a second plug terminal; a first magnet that is disposed so that one pole of the first magnet is opposed to a certain pole of the first support magnet when the first plug is inserted in the first receptacle, the certain pole of the first support magnet having the different polarity as the one pole of the first magnet; and a second magnet that is disposed so that one pole of the second magnet is opposed to a certain pole of the second support magnet when the second plug is inserted in the second receptacle, the certain pole of the second support magnet having the different polarity as the one pole of the second magnet. According to another embodiment, an electronic apparatus includes: a receptacle that is compatible with a plug having a plurality of support magnets around a plug terminal; a plurality of magnets that are disposed so that each one pole of the magnets are opposed to each certain pole of the support magnets when the plug is inserted in the receptacle in a predetermined angle around an axis of the plug terminal, the each certain pole having the same polarity as the each one pole.

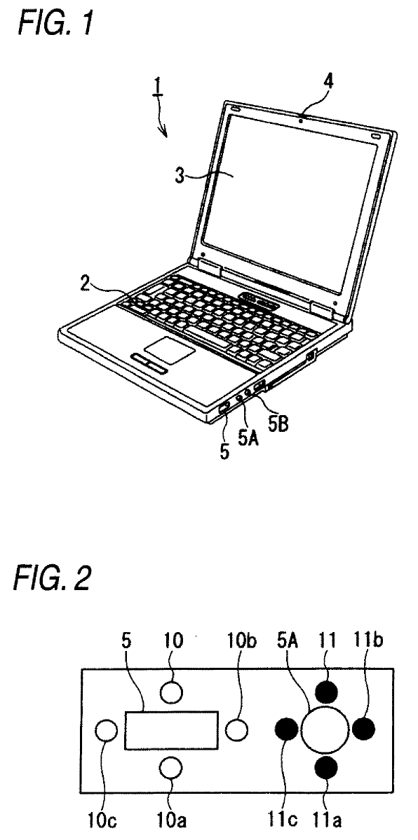

An electronic apparatus according to an embodiment of the present invention will be hereinafter described with reference to the accompanying drawings. FIG. 1 is a perspective view of an electronic apparatus 1 according to the embodiment. The electronic apparatus 1 is a notebook PC (personal computer). Alternatively it may be a PDA (personal digital assistant), a cell phone, or the like. As shown in FIG. 1, the electronic apparatus 1 is equipped with keys 2 which are depressed when a user inputs an instruction, a display 3 for displaying a picture of a text, an image, or the like, a speaker 4 for outputting sound, and connector units 5, 5A, and 5B into which the plug of a connection cable or the like is to be inserted. The keys 2, the display 3, the speaker 4, and the connector units 5, 5A, and 5B are exposed to the outside.

For example, a CPU (central processing unit) 11, a RAM (random access memory), an HD (hard disk) drive, a ROM (read-only memory), a GPU, an audio codec, etc. are incorporated in the electronic apparatus 1 so as to be connected to each other via a bus.

FIG. 2 is a front view of the connector units 5 and 5A of the electronic apparatus 1. The connector unit 5 is equipped with a connector into which an RJ45 plug 6 or an RJ11 plug, for example, is to be inserted. The RJ45 connector serves for connection of a cable and, more specifically, is an 8-core modular connector for use in Ethernet (registered trademark) cables, ISDN lines, etc. The RJ11 connector is another connector and, more specifically, is a 6-core modular connector for use in general telephone lines etc. The RJ11 connector is similar in shape to the RJ45 connector and is one-size smaller than the latter. The connector unit 5A is equipped with a connector into which a DC-in plug 6A, for example, is to be inserted.

In the connector unit 5, magnets 10, 10a, 10b, and 10c are disposed around (e.g., at four positions (above, below, left, and right)) an opening into which the plug 6 is to be inserted. Likewise, in the connector unit 5A, magnets 11, 11a, 11b, and 11c are disposed around (e.g., at four positions (above, below, left, and right)) an opening into which the plug 6A is to be inserted.

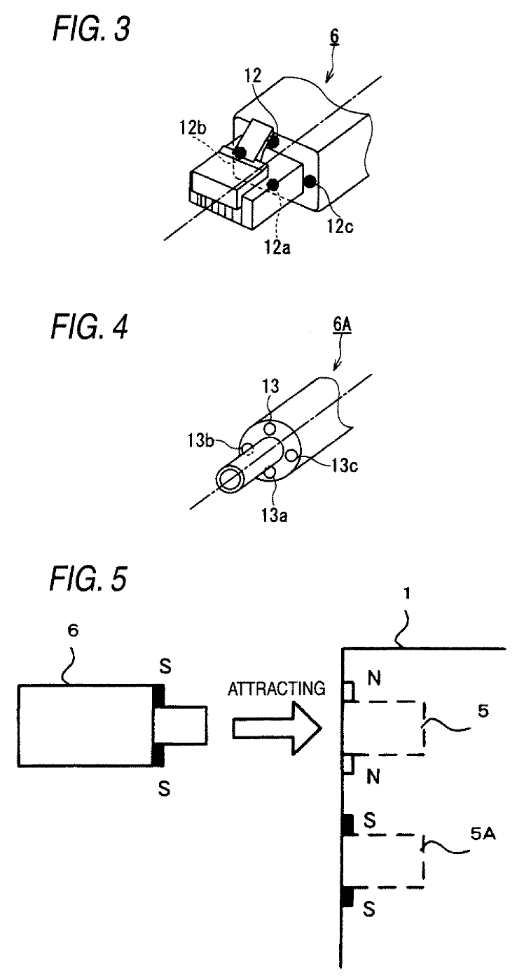

FIG. 3 is a perspective view of the RJ45 plug 6 to be inserted into the connector unit 5. In the plug 6, magnets 12, 12a, 12b, and 12c are disposed around (e.g., at four positions (above, below, left, and right)) a terminal to be inserted into the connector unit 5. FIG. 4 is a perspective view of a DC-in plug 6A to be inserted into the connector unit 5A. In the plug 6A, magnets 13, 13a, 13b, and 13c are disposed around (e.g., at four positions (above, below, left, and right)) a terminal to be inserted into the connector unit 5A.

The magnets 10, 10a, 10b, and 10c of the connector unit 5 are disposed at such position as to be opposed to the magnets 12, 12a, 12b, and 12c of the plug 6, respectively, in such a manner that their exposed sides have such a polarity that each opposed pair of magnets attract each other when the plug 6 is inserted into the connector unit 5. Likewise, the magnets 11, 11a, 11b, and 11c of the connector unit 5A are disposed at such positions as to be opposed to the magnets 13, 13a, 13b, and 13c of the plug 6A, respectively, in such a manner that their exposed sides have such a polarity that each opposed pair of magnets attract each other when the plug 6A is inserted into the connector unit 5A.

In FIGS. 2-10, the N-pole sides of magnets are indicated by white circles and the S-pole sides of magnets are indicated by black circles. For example, as shown in FIGS. 2 and 3, the N-pole sides of all of the magnets 10, 10a, 10b, and 10c of the connector unit 5 and the S-pole sides of all of the magnets 12, 12a, 12b, and 12c of the plug 6 are exposed. Therefore, as shown in FIG. 5, the plug 6 is inserted into the connector unit 5 smoothly because each opposed pair of magnets attract each other, that is, the magnets 10 and 12, the magnets 10a and 12a, the magnets 10b and 12b, and the magnets 10c and 12c attract each other.

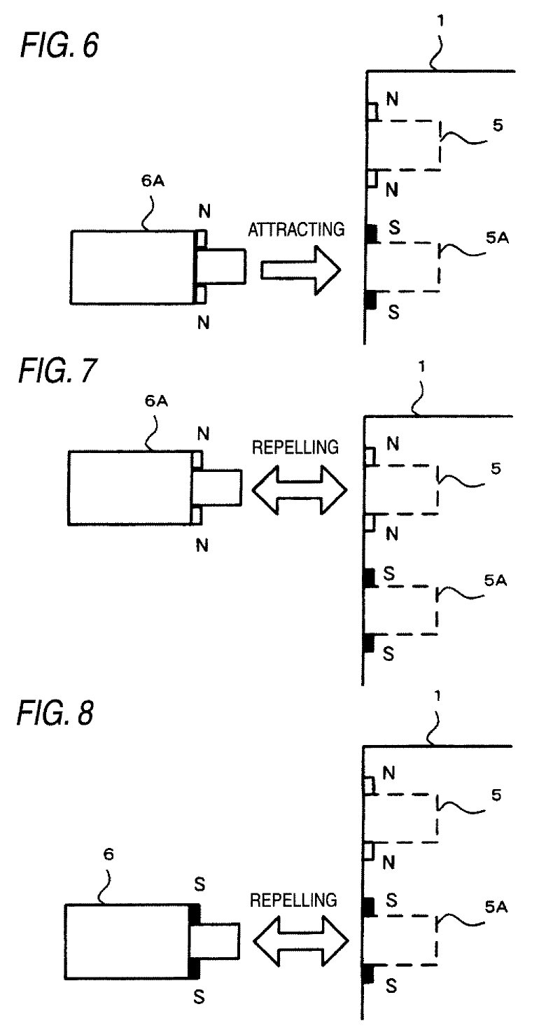

Likewise, as shown in FIGS. 2 and 4, the S-pole sides of all of the magnets 11, 11a, 11b, and 11c of the connector unit 5A and the N-pole sides of all of the magnets 13, 13a, 13b, and 13c of the plug 6A are exposed. Therefore, as shown in FIG. 6, the plug 6A is inserted into the connector unit 5A smoothly because each opposed pair of magnets attract each other, that is, the magnets 11 and 13, the magnets 11a and 13a, the magnets 11b and 13b, and the magnets 11c and 13c attract each other.

As shown in FIGS. 2 and 4, the N-pole sides of all of the magnets 10, 10a, 10b, and 10c of the connector unit 5 and the N-pole sides of all of the magnets 13, 13a, 13b, and 13c of the plug 6A are exposed. Therefore, as shown in FIG. 7, the plug 6A cannot be inserted into the connector unit 5 because each opposed pair of magnets repel each other, that is, the magnets 10 and 13, the magnets 10a and 13a, the magnets 10b and 13b, and the magnets 10c and 13c repel each other.

As shown in FIGS. 2 and 3, the S-pole sides of all of the magnets 11, 11a, 11b, and 11c of the connector unit 5A and the S-pole sides of all of the magnets 12, 12a, 12b, and 12c of the plug 6 are exposed. Therefore, as shown in FIG. 8, the plug 6 cannot be inserted into the connector unit 5A because each opposed pair of magnets repel each other, that is, the magnets 11 and 12, the magnets 11a and 12a, the magnets 11b and 12b, and the magnets 11c and 12c repel each other.

As described above, in the electronic apparatus 1, the magnets are disposed in the plugs 6 and 6A and the connector units 5 and 5A (into which the respective plugs 6 and 6A are to be inserted) in such a manner that the exposed sides of the magnets of each plug are opposite in polarity to those of the corresponding connector unit. Therefore, a user can insert the plugs 6 and 6A into the corresponding connector units 5 and 5A smoothly. On the other hand, the exposed sides of the magnets disposed in one of the adjoining connector units 5 and 5A are opposite in polarity to those of the magnets disposed in the other. This prevents an event that the plug 6 which is not compatible with the connector unit 5A is erroneously inserted into the connector unit 5A because of the repulsive forces acting between the magnets as well as an event that the plug 6A which is not compatible with the connector unit 5 is erroneously inserted into the connector unit 5 because of the repulsive forces acting between the magnets.

In particular, the terminal of the DC-in plug is smaller than the openings of the connector units that are compatible with the RJ45 plug and the RJ11 plug, respectively, and hence can be inserted into the openings of those connector units. Therefore, should the DC-in plug is inadvertently inserted into the opening of one of those connector units, the connector unit (RJ45 or RJ11) may be destroyed. However, erroneous insertion of the plug 6A (DC-in plug or the like) can be prevented because the exposed sides of the magnets of the connector unit 5 (RJ45, RJ11 or the like) and those of the plug 6A have such polarities as to repel each other.

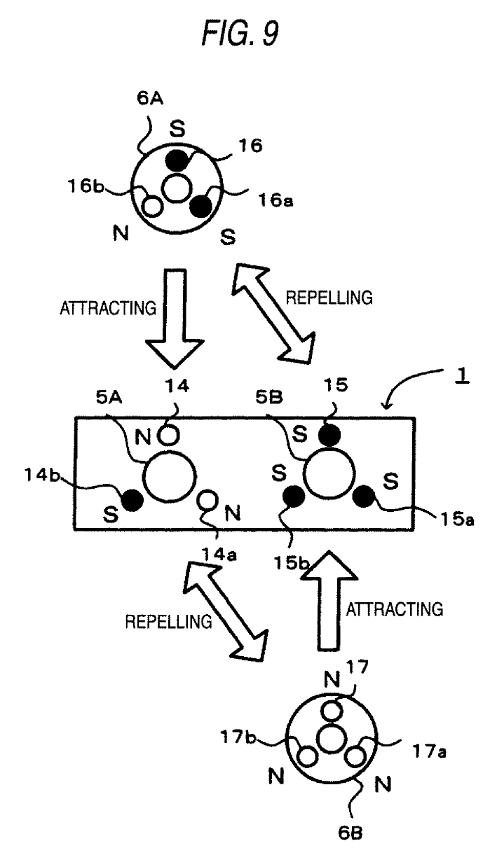

The polarities of the exposed sides of the magnets that are disposed in each of the connector sections 5, 5A, and 5B may be varied from one magnet to another. For example, as shown in FIG. 9, the connector unit 5B is equipped with a connector into which a PC/2 plug is to be inserted. PC/2 is a mini-DIN standard with a 6-core connection port and prescribes connectors that are used for a keyboard, a mouse, etc. A device that can be connected to each PS/2 connector is determined in advance; a mouse cannot be used being connected to a keyboard-dedicated connector and a keyboard cannot be used being connected to a mouse-dedicated connector.

In the connector unit 5A, magnets 14, 14a, and 14b are disposed around (e.g., at three positions) the opening into which the plug 6A is to be inserted. In the connector unit 5B, magnets 15, 15a, and 15b are disposed around (e.g., at three positions) the opening into which a plug 65 is to be inserted.

As shown in FIG. 9, in the plug 6A, magnets 16, 16a, and 16b are disposed around (e.g., at three positions) the terminal to be inserted into the connector unit 5A. In the plug 6B, magnets 17, 17a, and 17b are disposed around (e.g., at three positions) the terminal to be inserted into the connector unit 5B.

The magnets 14, 14a, and 14b of the connector unit 5A are disposed in such a manner that the magnets 16, 16a, and 16b of the plug 6A are located so as to correspond to the respective magnets 14, 14a, and 14b and the exposed sides of each opposed pair of magnets have such polarities as to attract each other when the plug 6A is inserted into the connector unit 5A. Likewise, the magnets 15, 15a, and 15b of the connector unit 5B are disposed in such a manner that the magnets 17, 17a, and 17b of the plug 6B are located so as to correspond to the respective magnets 15, 15a, and 15b and the exposed sides of each opposed pair of magnets have such polarities as to attract each other when the plug 6B is inserted into the connector unit 5B.

For example, the exposed sides of the magnets 14, 14a, and 14b of the connector unit 5A have the S pole, S pole, and N pole, respectively, and the exposed sides of the magnets 16, 16a, and 16b of the plug 6A have the N pole, N pole, and S pole, respectively. In this case, as shown in FIG. 9, the plug 6A is inserted into the connector unit 5A smoothly because each opposed pair of magnets attract each other, that is, the magnets 14 and 16, the magnets 14a and 16a, and the magnets 14b and 16b attract each other.

Likewise, for example, the exposed sides of all of the magnets 15, 15a, and 15b of the connector unit 5B have the N pole and the exposed sides of all of the magnets 17, 17a, and 17b of the plug 6B have the N pole. In this case, as shown in FIG. 9, the plug 6B is inserted into the connector unit 5B smoothly because each opposed pair of magnets attract each other, that is, the magnets 15 and 17, the magnets 15a and 17a, and the magnets 15b and 17b attract each other.

On the other hand, as shown in FIG. 9, the plug 6B cannot be inserted into the connector unit 5A because the two opposed pairs of magnets, that is, the magnets 14 and 17 and the magnets 14a and 17a repel each other.

Likewise, as shown in FIG. 9, the plug 6A cannot be inserted into the connector unit 5B because the two opposed pairs of magnets, that is, the magnets 15 and 16 and the magnets 15a and 16a repel each other.

As described above, in the electronic apparatus 1, the magnets are disposed in the plugs 6A and 6B and the connector units 5A and 5B (into which the plugs 6A and 6B are to be inserted) in such a manner that the exposed sides of each opposed pair of magnets of each corresponding set of a plug and a connector unit, that is, the plug 6A and the connector unit 5A or the plug 6B and the connector unit 5B, have opposite polarities. Therefore, a user can insert the plugs 6A and 6B into the respective connector units 5A and 5B smoothly. On the other hand, the polarities of the exposed sides of the magnets disposed in one of the adjoining connector units 5A and 5B are arranged differently than in the other of the adjoining connector units 5A and 5B. This prevents an event that the plug 6B which is not compatible with the connector unit 5A is erroneously inserted into the connector unit 5A because of the repulsive forces acting between the magnets as well as an event that the plug 6A which is not compatible with the connector unit 5E is erroneously inserted into the connector unit 5B because of the repulsive forces acting between the magnets. As a result, for example, where the plugs 6A and 6B are DC-in plugs of different output voltages, erroneous insertion of those plugs can be prevented by changing the arrangement of the polarities of the exposed sides of the magnets depending on the output voltage.

In particular, PS/2 plugs of a mouse and a keyboard, for example, are similar in shape and PS/2 connectors of a mouse and a keyboard, for example, are also similar in shape. Therefore, a user may be at a loss into which connector to insert a plug. However, since the polarities of the exposed sides of the magnets are arranged differently in plugs or connectors of a mouse, a keyboard, etc., a user can insert a plug into a connector smoothly by virtue of the attractive forces acting between the magnets only if they are a correct combination.

Where the plug 6B is a PC/2 plug, for example, its orientation (in both of the top/bottom and the right/left directions) to be employed when it is inserted into a corresponding connector is predetermined. Therefore, the plug 6B should be inserted being oriented so.

In the connector unit 5A, the magnets 14, 14a, and 14b are disposed around (e.g., at three positions) the opening into which the plug 6A is to be inserted. And in the connector unit 5B, the magnets 15, 15a, and 15b are disposed around (e.g., at three positions) the opening into which the plug 6B is to be inserted.

In the plug 6A, the magnets 16, 16a, and 16b are disposed around (e.g., at three positions) the terminal to be inserted into the connector unit 5A. And in the plug 6B, the magnets 17, 17a, and 17b are disposed around (e.g., at three positions) the terminal to be inserted into the connector unit 5B.

The magnets 14, 14a, and 14b of the connector unit 5A are disposed in such a manner that the magnets 16, 16a, and 16b of the plug 6A are located so as to correspond to the respective magnets 14, 14a, and 14b and the exposed sides of each opposed pair of magnets have such polarities as to attract each other when the plug 6A is inserted into the connector unit 5A with a correct orientation. And the magnets 14, 14a, and 14b of the connector unit 5A are disposed in such a manner that the exposed sides of the magnets 14, 14a, and 14b of the connector unit 5A and those of the magnets 16, 16a, and 16b of the plug 6A have such polarities as not to attract each other when the plug 6A is inserted into the connector unit 5A with an erroneous orientation.

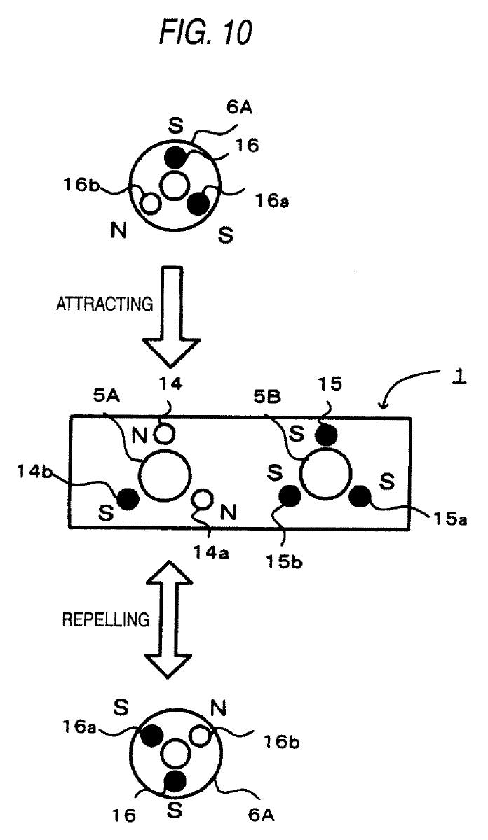

For example, the exposed sides of the magnets 14, 14a, and 14b of the connector unit 5A have the S pole, S pole, and N pole, respectively, and the exposed sides of the magnets 16, 16a, and 16b of the plug 6A have the N pole, N pole, and S pole, respectively. In this case, as shown in FIG. 10, the plug 6A is inserted into the connector unit 5A smoothly because each opposed pair of magnets attract each other, that is, the magnets 14 and 16, the magnets 14a and 16a, and the magnets 14b and 16b attract each other, as long as the plug 6A is oriented correctly.

On the other hand, as shown in FIG. 10, if it is attempted to insert the plug 6A into the connector unit 5A with an erroneous orientation (e.g., upside down), the plug 6A cannot be inserted into the connector unit 5B because each of the three pairs of magnets that should be opposed to each other are not opposed to each other, that is, the magnets 14 and 16, the magnets 14a and 16a, and the magnets 14b and 16b, are not opposed to each other (the magnets repel each other).

As described above, in the electronic apparatus 1, the magnets 14, 14a, and 14b of the connector 5A and the magnets 16, 16a, and 16b of the plug 6A are disposed in such a manner that the exposed sides of each opposed pair of magnets have opposite polarities only when the plug 6A is inserted with a correct orientation. Therefore, a user can insert the plug 6A into the connector unit 5A smoothly. When it is attempted to insert the plug 6A into the connector unit 5A with an erroneous orientation, the repulsive forces acting between the magnets prevent the insertion.

In the electronic apparatus according to the invention, magnets are provided in a connector unit and a plug to be inserted into the connector unit so that the connector unit and the plug attract each other when the latter is inserted into the former. Therefore, an electronic apparatus is provided which can be manufactured at a low cost and can prevent destruction of a connector due to insertion of a non-compatible plug because it incorporates connectors that allow insertion of only compatible plugs.

As described with reference to the embodiment, there is provided an electronic apparatus which is manufactured at a low cost and prevents destruction of a connector due to insertion of a non-compatible plug because it incorporates connectors that allows insertion of only compatible plugs.

1. An electronic apparatus comprising:
a receptacle compatible with a plug having a plurality of support magnets; and
a plurality of magnets disposed around an opening of the receptacle so that the plurality of magnets oppose to the plurality of support magnets and the plurality of magnets pull the opposing plurality of support magnets by magnetic force when the plug is inserted in the receptacle in a given condition, the plurality of magnets being a number of at least three, and at least one of the plurality of magnets having one polar character and at least one of the of the plurality of magnets having the opposite polar character.

2. The electronic apparatus according to claim 1, wherein the plug is a DC-in plug.

3. An electronic apparatus comprising:
a first receptacle that is compatible with a first plug having a first support magnet around a first plug terminal;
a second receptacle that is compatible with a second plug having a second support magnet around a second plug terminal;
a first magnet that is disposed around an opening of the first receptacle so that a pole of the first magnet is opposed to a pole of the first support magnet when the first plug is inserted in the first receptacle, the pole of the first support magnet having a different polarity from the pole of the first magnet; and
a second magnet that is disposed around an opening of the second receptacle so that a pole of the second magnet is opposed to a pole of the second support magnet when the second plug is inserted in the second receptacle, the pole of the second support magnet having a different polarity from the pole of the second magnet.

4. The electronic apparatus according to claim 3, wherein the first receptacle is provided adjacent to the second receptacle, and
wherein the first support magnet has the different polarity from the second support magnet.

5. An electronic apparatus comprising:
a receptacle that is compatible with a plug having a plurality of support magnets around a plug terminal; and
a plurality of magnets that are disposed around an opening of the receptacle so that each pole of the plurality of magnets is opposed to each pole of the plurality of support magnets when the plug is inserted in the receptacle at a predetermined angle around an axis of the plug terminal, each pole of the plurality of support magnets having a different polarity from each pole of the plurality of magnets.

6. The electronic apparatus according to claim 5,
wherein the plurality of magnets are disposed to repel the plurality of support magnets when the plug is inserted in the receptacle unless the plug is inserted at the predetermined angle.

7. The electronic apparatus according to claim 1 further comprising:
a second receptacle that is not compatible with the plug; and
a plurality of second magnets disposed around the second receptacle so that the plurality of second magnets oppose to the plurality of support magnets and the plurality of second magnets push at least one of the opposing plurality of support magnets by magnetic force when the plug is inserted in the second receptacle.

8. The electronic apparatus according to claim 1, wherein the plurality of magnets push at least one of the opposing plurality of support magnets by magnetic force when the plug is inserted in the receptacle in a condition other than the given condition.
